(19) United States
(12) Patent Application Publication
(10) Pub. No.: US 2009/0113440 A1
(43) Pub. Date: Apr. 30, 2009

(54) Multiple Queue Resource Manager

(76) Inventor: Jared B. Dorny, Aurora, CO (US)

Correspondence Address: BAKER BOTTS LLP, 2001 ROSS AVENUE, 6TH FLOOR, DALLAS, TX, 75201-2980, US

(21) Appl. No.: 11/929,285

(22) Filed: Oct. 30, 2007

(51) Int. Cl. G06F 9/50

(52) U.S. Cl. 718/104

(57) ABSTRACT

In one embodiment, a multiple queue resource manage includes a number of queues in communication with at least one thread. The queues are coupled to each of a corresponding number of clients and operable to receive messages from its respective client. The at least one thread is coupled to a processor configured in a computing system and operable to alternatively process a specified quantity of the messages from each of the plurality of queues.

### TECHNICAL FIELD OF THE DISCLOSURE

This disclosure relates generally to computing systems, and more particularly, to a multiple queue resource manager and a method of operating the same.

### BACKGROUND OF THE DISCLOSURE

Advances is computer technology have enabled the implementation of applications that were heretofore generally impractical using older computing systems. Processing speed is one particular aspect of computing systems that has enabled use of these new applications. To further increase effective processing speed, modern computing systems may utilize multiple processors that are configured to execute computer instructions in a parallel fashion. In this manner, multiple algorithms may be processed simultaneously to increase the overall throughput of the computing system.

### SUMMARY OF THE DISCLOSURE

In one embodiment, a multiple queue resource manager includes a number of queues coupled to at least one thread. The queues are in communication with each of a corresponding number of clients and operable to receive messages from its respective client. The at least one thread is in communication with a processor configured in a computing system and operable to alternatively process a specified quantity of the messages from each of the plurality of queues.

Some embodiments of the disclosure provide numerous technical advantages. Some embodiments may benefit from some, none, or all of these advantages. For example, according to one embodiment, alternatively processing a specified quantity of messages from each of the plurality of queues may distribute processing load to each of a plurality of processors configured in the computing system in a generally even manner. The cyclic nature in which messages are processed through each of the queues may cause a relatively even amount of messages to be processed by each processor in some embodiments.

Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a diagram showing one embodiment of a multiple queue resource manager that may be implemented on a computing system according to the teachings of the present disclosure;

FIG. 2A is one embodiment of a multiple queue resource manager class structure that may be compiled to form the multiple queue resource manager of FIG. 1;

FIG. 2B is one embodiment of a queue class structure that may be compiled with the multiple queue resource manage class structure of FIG. 2;

FIG. 3 is as time chart showing one embodiment of a sequence of messages that may be processed by the multiple queue resource manager of FIG. 1; and

FIG. 4 is a flowchart showing a series of actions that may be performed by the multiple queue resource manager of FIG. 1.

### DETAILED DESCRIPTION OF EXAMPLE EMBODIMENTS OF THE DISCLOSURE

Modern computing systems may utilize a multiple number of processors to increase its effective processing speed. Although computing systems incorporating multiple processors have the capability of enhanced processing speed, this capability has not been well implemented. For example, a messaging system may be implemented to facilitate the transmission and receipt of messages from a number of clients to a socket, such as a gateway or portal. One or more of these clients, however, may transmit an inordinately large quantity of messages that may in turn hamper access to the messaging system by other clients. One approach to this problem has been to create a thread for each client and process the client's messages through this thread. This approach, however, has a drawback in that a large quantity of messages from a single client may flood the processor and effectively block other threads from having access to the processor.

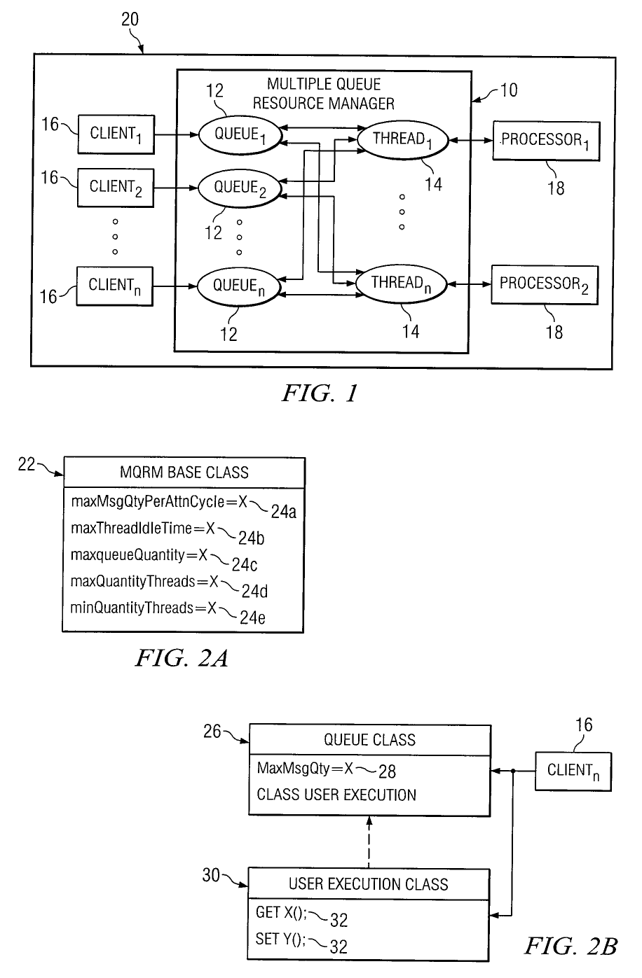

FIG. 1 shows one embodiment of a multiple queue resource manager 10 that may provide a solution to the previously described problems as well as other problems. Multiple queue resource manager 10 may have a number of queues 12 and one or more threads 14 for managing messages from a number of clients 16 to one or more processors 18 on a computing system 20. As will be described in detail below, multiple queue resource manager 10 may be operable to generate queues 12 that temporarily store messages from a corresponding number of clients 16 for controlled delegation of processing load to each of the processors 18 in a generally even manner.

Multiple queue resource manager 10 may be executable on any suitable computing system 20 having one or more processors 18. For example, multiple queue resource manager 10 may include logic stored in a computer-readable medium, such as, random access memory (RAM), and/or other types of non-volatile memory.

Computing system 20 may be a network coupled computing system or a stand-alone computing system. In one embodiment, the stand-alone computing system may be any suitable computing system, such as a personal computer, laptop computer, or mainframe computer that executes program instructions for executing the multiple queue resource manager 10 according to the teachings of the present disclosure. In another embodiment, the network computing system may be a number of computer systems coupled together via a network, such as a local area network (LAN), a metropolitan area network (MAN), or a wide area network (WAN). The multiple queue resource manager 10 implemented on a network computer system may enable access by clients 16 configured on other computing systems and in communication with the multiple queue resource manager 10 through the network.

Clients 16 may be any type of device wishing to process messages through the one or more processors 18. In one embodiment, clients 16 may be communication terminals that are configured to transmit and receive messages from another remote terminal. In another embodiment, clients 16 may be independently executed processes on computing system 20 in which messages may be portions of executable programs to be executed by processors 18 or any of various types of internal system calls. In one embodiment, a queue 12 may be created for each client 16 wishing to process messages through the one or more processors 18. Each queue 12 may exist for any suitable period of time as specified by its respective client 16. When use of the queue 12 is no longer needed or desired, the queue 12 may be killed by its respective client 16. At a later time, the client 16 may create another queue 12 for processing of further messages by the one or more processors 18.

Each queue 12 may be configured to temporarily store messages in route from its respective client 16 to the one or more processors 18. In one embodiment, each queue 12 may temporarily store messages in a first-in-first-out (FIFO) fashion. In another embodiment, each queue 12 may employ a scheduling mechanism for processing of temporarily stored messages. For example, the queue 12 may use a scheduling mechanism that processes messages according to a priority parameter associated with each message or drops messages from the queue 12 based on this priority parameter. In another embodiment, the scheduling mechanism may use parameters that are set by its respective client 16.

The multiple queue resource manager 10 may be operable to create any suitable quantity of threads 14 for processing of messages. In one embodiment, the multiple queue resource manager 10 may create a quantity of threads 14 that are equal to the quantity of processors 18 implemented in the computing system 20. In this manner, each thread 14 may be dedicated to transmit messages to one particular processor 18 such that processing load may be distributed to each of the processors 18 in the computing system 20. In the particular embodiment shown in FIG. 1, computing system 20 has two processors 18 such that the multiple queue resource manager 10 may generate two threads 14 for managing messages from the various clients 16. It should be appreciated, however, that multiple queue resource manager 10 may create any suitable quantity of threads 14 for use with any numbers of processors 18 configured in computing system 20.

FIG. 2A shows one embodiment of a multiple queue resource manager class structure 22 that may be used by a suitable compiler to generate program instructions according to an object oriented model. That is, the multiple queue resource manager 10 may be instantiated into an executable process on computing system 20 from multiple queue resource manager class structure 22 according to common object oriented programming principles. The multiple queue resource manager class structure 22 generally includes a number of variables 24 that may be set to specified values before instantiation or during run-time of the multiple queue resource manager 10 on computing system 20. The variables 24 may include a “maximum quantity per attention cycle” variable 24a, a “maximum thread idle time” variable 24b, a “maximum queue quantity” variable 24c, a “maximum quantity of threads” variable 24d, and a “minimum quantity of threads” variable 24e. It should be appreciated that other variables and methods may be specified for use with multiple queue resource manager class structure 22; however, only several variables are shown in this particular embodiment for purposes of brevity and clarity of disclosure.

The “maximum quantity per attention cycle” variable 24a may refer to a specified quantity of messages that may be processed by each queue 12 during each cycle. Once the specified quantity of messages of any one particular queue 12 are processed, the thread 14 may then commence processing of messages from another one of the queues 12.

The “maximum thread idle time” variable 24b may indicate a maximum idle time that any one thread 14 may wait for a message to process from any one particular queue 12. The “maximum thread idle time” variable 24b may work in conjunction with the “maximum quantity per attention cycle” variable 24a to limit time spent processing messages from any one particular queue 12. For example, a thread 14 may have processed pending messages in a particular queue 12 without having processed the specified quantity of messages as indicated in the “maximum quantity per attention cycle” variable 24a. Thus, even through the specified quantity from that particular queue 12 has not be met, the maximum idle time indicated by the “maximum thread idle time” variable 24b may allow the thread 14 to commence processing other messages from another queue 12.

The “maximum queue quantity” variable 24c may indicate a maximum quantity of queues 12 that may be created by the multiple queue resource manager 10. The “maximum thread quantity” variable 24d and “minimum thread quantity” variable 24e indicate the maximum quantity and minimum quantity, respectively, of threads 14 that may be created by the multiple queue resource manager 10.

FIG. 2B shows one embodiment of a queue class structure 26 that may be structured according to object oriented programming principles and be compiled into program instructions by a suitable compiler such that when executed, queues 12 may be instantiated by the clients 16. The queue class structure 26 may have an association established with the multiple queue resource manager class structure 22 such that messages received from the client 16 by a queue 12 instantiated according to the queue class structure 26 may be buffered for use by the multiple queue resource manager 10. Thus, one particular client 16 may create an instance of a queue 12 from the queue class structure 26 and subsequently pass messages to the processors 18 through this queue 12 if the “maximum queue quantity” variable 24c has not been exceeded. In one embodiment, queue class structure 26 may include a “maximum message quantity” variable 28 that limits the quantity of messages that may be stored in the queue 12 at any one time.

In one embodiment, a user execution class structure 30 may be provided to allow implementation of user generated methods 32. The user generated methods 32 may be any suitable type of operation to be performed on messages that are its respective queue 12. The user execution class structure 30 shown includes two example methods 32, such as a get( ) method and a set( ) method. These example methods 32 may be generated by the user to perform any customized operation on messages that transmitted to and from the processors 18.

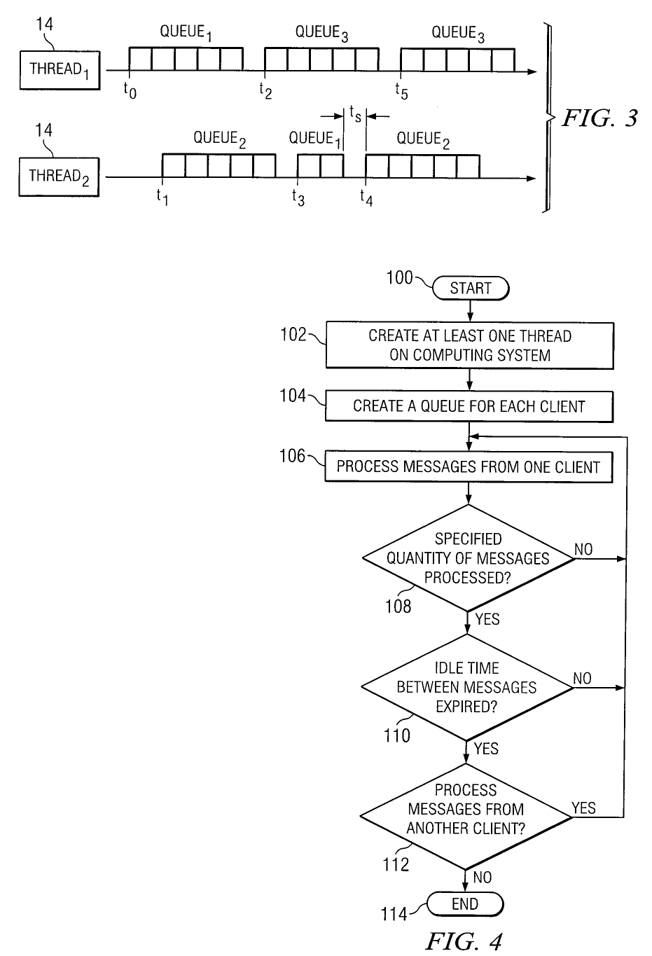

FIG. 3 is a time chart showing one embodiment of how messages may be processed by the multiple queue resource manager 10. In this particular embodiment, two threads 14 may be created to process messages from three queues 12. Nevertheless, it should be appreciated that any number of threads 14 may be used with any number of queues 12. Also in this particular embodiment, the “maximum message quantity per attention cycle” variable 24a may be set to five; however, other embodiments may be implemented with the “maximum message quantity per attention cycle” variable 24a set to any suitable quantity.

At time t₀, thread₁ 14 may process five messages from queue₁ 12. While these messages are being processed, thread₂ 14 may process five more messages from queue₂ 12 beginning at time t₁. At time t₂, thread₁ 14 may process five more messages from queue₃ 12. Processing of messages from all of the existing queues 12 may be generally referred to as a cycle. To process messages in another cycle, thread₂ 14 may process messages from queue₁ 12 beginning at time t₃. At time t₃, however, queue₁ 12 only has two messages to be processed. Thus, thread₂ 14 may wait for a specified time tₛ as indicated in the “maximum thread idle time” variable 24b and then commence processing messages from queue₂ 12 at time t₄. At time t₅, thread₁ 14 commences processing of more messages from queue₃ 12. The previously described process continues for each queue 12 instantiated by a client 16. During this process, one or more queues 12 may be deleted and other queues 12 may be added while maintaining a relatively even throughput of messages from each client 16 to the processors 18.

FIG. 4 is a flowchart showing one embodiment of a series of actions that may be performed by the multiple queue resource manager 10 to distribute messages from a number of clients 16 to at least one processor 18. In act 100, the process is initiated. The process may be initiated by applying power to and performing any bootstrapping operations to the computing system 20 and coupling a plurality of clients 16 to the computing system 20 in any suitable manner.

In act 102, the multiple queue resource manager 10 may create at least one thread 14 on computing system 20. In one embodiment, a number of threads 14 equal to the number of processors 18 configured on computing system 20 may be created. In another embodiment, the multiple queue resource manager 10 may include a “maximum quantity of threads” variable 24d and a “minimum quantity of threads” variable 24e that may provide user control of the maximum and minimum quantity, respectively, of threads 14 that may be created by multiple queue resource manager 10.

In act 104, the multiple queue resource manager 10 may create a queue 12 for each of a plurality of clients 16 desiring to transmit messages to the processors 18. Each queue 12 may be coupled to its respective client 16 and be operable to buffer messages transmitted to the processors 18. In one embodiment, a “maximum queue quantity” variable 24c may be provided that limits the maximum quantity of queues 12 created by multiple queue resource manager 10.

In act 106, the multiple queue resource manager 10 may process messages from one of the clients 16. The multiple queue resource manager 10 may process messages by forwarding messages temporarily stored in queue 12 to a processor 18 through one thread 14. In a particular embodiment in which multiple threads 14 have been created for a corresponding multiple processors 18, one processor 18 which is not busy may be used to process the messages.

In act 108, the multiple queue resource manager 10 may continue processing messages from the one client 16 until a specified quantity of messages have been processed. In one embodiment, the specified quantity may be user selectable using a “maximum quantity of messages per attention cycle” variable 24a. By implementation of the “maximum quantity of messages per attention cycle” variable 24a, ensures that a relatively large quantity of messages from one particular client 16 does not cause messages from another client 16 to remain un-serviced for a relatively long period of time in some embodiments.

In act 110, the multiple queue resource manager 10 may verify that an idle time between messages from the client 16 has not exceeded a specified idle time. In one embodiment, the specified idle time may be a user selectable value that is set using a “maximum thread idle time” variable 24b. Certain embodiments incorporating a “maximum thread idle time” variable 24b may allow the multiple queue resource manager 10 to process messages from other clients 16 in the event that the client 16 has no further messages to process at that time.

In act 112, the multiple queue resource manager 10 may continue processing messages from another client 16 by continuing operation at act 106. That is, the multiple queue resource manager 10 may continually repeat acts 106 through acts 110 for each of the multiple queues 12 created by the multiple queue resource manager 10. In this manner, messages from each of the multiple clients 16 may be distributed to the processors 18 in a generally even manner.

The next queue 12 to be serviced by the thread 14 may be based upon any suitable approach. In one embodiment, the next queue 12 to be serviced may be based upon a latency time of the next queue 12 since the last service. That is, the thread 14 may select the next queue 12 for service that has been waiting the relatively longest period of time. In another embodiment, the next queue 12 to be serviced may be based upon a latency time and a quantity of messages currently waiting service. That is, the queue 12 may apply a weighting factor including the quantity of messages currently stored in the queue 12 to obtain priority over other queues 12 having relatively fewer messages to be processed.

In another embodiment, each message stored in one of the queues 12 may include a priority tag that allows messages within each queue 12 to be processed according to its respective priority tag.

Continuing with the description of act 112, if no further queues 12 are to be processed, however, processing continues at act 114 in which the system is halted.

A multiple queue resource manager 10 has been described that may provide distributed processing of messages from multiple clients 16 to one or more processors 18 configured in computing system 20. The multiple queue resource manager 10 provides queues 12 for each client 16 that are serviced in a cyclical manner to ensure that any particular client 16 is serviced by one of the processors 18 in a timely manner. The multiple queue resource manager 10 may include a number of variables 24 that allow customization of how messages for use in various computing environments and under differing types of anticipated processing work loads.

Although the present disclosure has been described in detail, it should be understood that various changes, substitutions, and alterations can be made hereto without departing from the spirit and scope of the disclosure as defined by the appended claims.

What is claimed is:

1. A computing system comprising:
a multiple queue resource manager in communication with a plurality of clients and at least one processor configured in the computing system, the multiple queue resource manager operable to:
create a plurality of queues for each of the plurality of clients, each of the plurality of queues operable to receive messages from its respective client; and
create at least one thread that is coupled to the at least one processor, the at least one thread being configured to alternatively process a specified quantity of the messages from each of the plurality of queues.

2. The computing system of claim 1, wherein the at least one thread is a plurality of threads that is equivalent to the quantity of processors in the computing system.

3. The computing system of claim 1, wherein the queue is further operable to temporarily store the messages and block receipt of further messages from its respective client if the stored messages exceeds a second specified quantity.

4. The computing system of claim 1, in which the multiple queue resource manager is written with program instructions according to an object oriented model, each of the plurality of queues being configured to implement at least one user generated method.

5. The computing system of claim 1, wherein the multiple queue resource manager is operable to alternatively process the specified quantity of messages from another queue if the one of the plurality of threads is idle for longer than a maximum specified time.

6. The computing system of claim 1, wherein the at least one thread is a plurality of threads, the logic being further operable to limit creation of the plurality of threads to a maximum specified quantity.

7. The computing system of claim 1, wherein the at least one thread is a plurality of threads, the logic being further operable to limit creation of the plurality of threads to a minimum specified quantity.

8. The computing system of claim 1, wherein each of the plurality of threads is operable to select another queue for processing based on a priority level.

9. The computing system of claim 8, wherein the priority level is based on a last executed time of the another queue or a quantity of the plurality of messages in the queue.

10. Logic embodied on a computer-readable medium, operable, when executed by a processor, to:
create a plurality of queues for each of a corresponding plurality of clients, each of the plurality of queues operable to receive messages from its respective client; and
create at least one thread on a computing system, the at least one thread being configured to alternatively process a specified quantity of the messages from each of the plurality of queues.

11. The logic of claim 10, wherein the at least one thread is a plurality of threads that is equivalent to the quantity of processors in the computing system.

12. The logic of claim 10, wherein the logic is operable to alternatively process the specified quantity of messages from another queue if the one of the plurality of threads is idle for longer than a maximum specified time.

13. The logic of claim 10, wherein the at least one thread is a plurality of threads, the logic being further operable to limit creation of the plurality of threads to a maximum specified quantity.

14. The logic of claim 10, wherein the at least one thread is a plurality of threads, the logic being further operable to limit creation of the plurality of threads to a minimum specified quantity.

15. The logic of claim 10, wherein each of the plurality of threads is operable to select another queue for processing based on a priority level.

16. The logic of claim 15, wherein the priority level is based on a last executed time of the another queue or a quantity of the plurality of messages in the queue.

17. A method for managing a plurality of clients comprising:
processing, through one of a plurality of queues, a plurality of messages from one of the plurality of clients using at least one processor configure on a computing system;
comparing a quantity of messages processed with a specified quantity; and
processing, through another one of the plurality of queues, a second plurality of messages from another one of the plurality of clients when the quantity of messages is equivalent to the specified quantity.

18. The method of claim 17, further comprising comparing an elapsed time between messages received by the client and a specified time and when the elapsed time is equivalent to the specified time, processing, the second plurality of messages from the another one of the plurality of clients.

19. The method of claim 17, wherein processing a plurality of messages from the one of the plurality of clients using at least one processor further comprises processing a plurality of messages from one of the plurality of clients using a plurality of processors.

20. The method of claim 17, further comprising selecting the another one of the plurality of clients based upon a priority level.
